(19) United States
(12) Patent Application Publication
(10) Pub. No.: US 2015/0228019 A1
(43) Pub. Date: Aug. 13, 2015

(54) SYSTEM AND METHOD FOR FACILITATING SOCIAL TRADING

(71) Applicants: Jonathan Alexander ASSIA, Savion (IL); ETORO GROUP LTD, Road Town, Tortola (VG)

(72) Inventor: Johnathan Alexander Assia, Savion (IL)

(21) Appl. No.: 14/427,718

(22) PCT Filed: Sep. 11, 2013
(86) PCT No.: PCT/IL13/50771

§ 371 Date: Mar. 12, 2015

Related U.S. Application Data
(60) Provisional application No. 61/700,137, filed on Sep. 12, 2012.

(51) Int. Cl. G06Q 40/04

(52) U.S. Cl. CPC G06Q 40/04

(57) ABSTRACT

A method of facilitating social trading, the method comprising receiving, from a first user associated with a first user trading account, one or more reference account selection criterions, generating a social index for the first user trading account, comprising an indication of one or more selected reference accounts, selected from a plurality of reference accounts that meet the reference account selection criterions, and automatically generating at least one trade order for the first user trading account, each of the at least one trade order relating to a respective financial asset, based on automatic trading rules, wherein the automatic trading rules depend on trading activities of the one or more selected reference accounts.

### CROSS-REFERENCES TO RELATED APPLICATIONS

This application claims priority from U.S. provisional patent application No. 61/700,137 filed on Sep. 12, 2012, which is incorporated herein by reference in its entirety.

### TECHNICAL FIELD

The presently disclosed subject matter relates to the field of automatic trading systems and more specifically to a system and method for facilitating social trading of financial assets.

### BACKGROUND

In financial markets, traders of stocks, bonds, Forex, commodities, or any other financial instruments can generally be classified into two groups—those who practice fundamental analysis of financial information (earnings, dividends, etc.), and those who rely on automatic tools for predicting market trends.

Whereas the first group of traders may employ a great deal of analysis methods, the second group can generally be divided into the following two main approaches:

Technical analysis—forecasting the direction of prices through the study of past market data (primarily price and volume). Such methods rely heavily on finding correlations between changes in market indices, and the development of mathematical predictive models based on the above. Examples for such techniques are the Elliott Wave Theory, Dow Theory, and others.

Data analysis—based on an automatic analysis of very large quantities of data such as newspaper articles, blog posts, messages in financial forums, and so on. The main techniques used for data analysis are usually borrowed from the field of supervised or unsupervised machine learning, and often involve breaking down the input data into small chunks of simple sentences and searching for statistical correlations between appearances of certain combinations and concurrent market trends.

In electronic financial markets, algorithmic trading or automated trading, also known as “algo-trading”, “black-box trading” or “robo-trading”, is the use of computer programs for entering, generating and executing trading orders, with the computer algorithm deciding on aspects of the order such as the timing, price, or quantity of the order, or in many cases initiating the order without human intervention. A special class of algorithmic trading is “high frequency trading” (HFT), in which computers make elaborate decisions to initiate orders based on information that is received electronically, before human traders are capable of processing the information they observe.

Algorithmic trading may be used in any investment strategy, including market making, inter-market spreading, arbitrage, or pure speculation (including trend following). The investment decision and implementation may be augmented at any stage with algorithmic support or may operate completely automatically (“on auto-pilot”).

Algo-Trading, however, is still in its infancy, rapidly developing as computational and data mining technologies develop. Traders continue to search for any advantage that may be gained through automated analysis of data relating to trade.

There is therefore a need for improved methods and systems for facilitating social trading of financial assets.

References considered to be relevant as background to the presently disclosed subject matter are listed below. Acknowledgement of the references herein is not to be inferred as meaning that these are in any way relevant to the patentability of the presently disclosed subject matter.

### GENERAL DESCRIPTION

With the recent increase in electronic markets openness, and the expanded growth in the number of Internet based financial services in the last decade, a new kind of algorithmic trading strategy has now been enabled—which may be referred to as “social trading”.

Based on the fact that there are nowadays enormous amounts of user generated financial and trading information available online, and the assumption that at least some of this information contains valuable insights or some other understanding or knowledge regarding the markets, a new type of automatic or algorithmic trading mechanism is possible, that would be based on this information. Such a trading method may be called a Social Trading method, as it is based on the information gathered in social environments, in social contexts, or by social interactions. This information may include the actual trading activities performed by other traders. A formal way of describing, analyzing and acting upon this information may be provided, which may be denoted as Computational Social Finance, or Computational Social Trading.

With the spread of pervasive computing systems, an increasing fraction of human interactions nowadays are being digitally captured. These digital breadcrumbs, combined with substantial computational power, create enormous opportunities for groundbreaking science. Investigating these newly available pieces of information, seeking internal correlations, as well as correlations with global behaviors, can lead to an improved understanding of collective human behavior.

The study of the correlation between social interactions and the ability of communities to complete complicated tasks is therefore of extremely high relevance in today's connected world, and of specific applicability for financial trading, due to the enablement of Social Trading. To date, there has been no analytical quantitative research of the “efficient” way to manage social based interactions for the purpose of financial trading.

In accordance with an aspect of the presently disclosed subject matter, there is provided a method of facilitating social trading, the method comprising:
receiving, from a first user associated with a first user trading account, one or more reference account selection criterions;
generating a social index for the first user trading account, comprising an indication of one or more selected reference accounts, selected from a plurality of reference accounts that meet the reference account selection criterions; and
automatically generating at least one trade order for the first user trading account, each of the at least one trade order relating to a respective financial asset, based on automatic trading rules, wherein the automatic trading rules depend on trading activities of the one or more selected reference accounts.

In accordance with an embodiment of the presently disclosed subject matter, there is further provided a method wherein the selected reference accounts include two or more user trading accounts.

In accordance with an embodiment of the presently disclosed subject matter, there is yet further provided a method further comprising executing the at least one trade order.

In accordance with an embodiment of the presently disclosed subject matter, there is yet further provided a method further comprising calculating a score for the social index based on one or more trading performance parameters of the social index in a certain time frame.

In accordance with an embodiment of the presently disclosed subject matter, there is yet further provided a method wherein the reference account selection criterions include one or more of the following parameters of the one or more reference accounts: trading time frame, user trading account balance, the calculated score of the social index, number of linked copier accounts, gain ratio, winning ratio, maximum drawdown, leverage, exposure, and any combination or derivative thereof.

In accordance with an embodiment of the presently disclosed subject matter, there is yet further provided a method wherein the one or more selected reference accounts are automatically selected.

In accordance with an embodiment of the presently disclosed subject matter, there is yet further provided a method, wherein the automatically selecting is performed according to the ranking of the plurality of reference accounts by the one or more parameters.

In accordance with an embodiment of the presently disclosed subject matter, there is yet further provided a method wherein the one or more selected reference accounts are manually selected.

In accordance with an embodiment of the presently disclosed subject matter, there is yet further provided a method wherein generating the social index further comprises assigning respective weight factors to each of the one or more selected reference accounts.

In accordance with an embodiment of the presently disclosed subject matter, there is yet further provided a method, wherein the automatic trading rules include copying at least one trade order executed for the one or more selected reference accounts, with an allocated amount of account balance of the first user trading account, based on the account balance of the first user trading account, the investment portfolios of each respective selected reference account and the respective weight factors associated with the respective selected reference account.

In accordance with an embodiment of the presently disclosed subject matter, there is yet further provided a method wherein automatically generating the at least one trade order includes:
aggregating trade orders relating to respective financial assets, wherein the trade orders are executed for at least two of the selected reference accounts, and generating aggregated trade orders for the first user trading account.

In accordance with an embodiment of the presently disclosed subject matter, there is yet further provided a method wherein the automatic trading rules include a condition dependent on one or more of the following variables: market events, market history, open positions of the first user trading account, account balance of the first user trading account, trading activities of the one or more selected reference accounts and any combination or derivative thereof.

In accordance with an embodiment of the presently disclosed subject matter, there is yet further provided a method further comprising generating, upon regeneration criteria being met, an updated social index comprising an indication of one or more newly selected reference accounts, selected from the plurality of reference accounts that meet the reference account selection criterions.

In accordance with an embodiment of the presently disclosed subject matter, there is yet further provided a method wherein the generating an updated social index further comprises assigning respective new weight factors to each of the one or more newly selected reference accounts.

In accordance with an embodiment of the presently disclosed subject matter, there is yet further provided a method wherein the receiving further comprises receiving, from the first user associated with the first user trading account, one or more automatic trading rules.

In accordance with an aspect of the presently disclosed subject matter, there is yet further provided a system for social trading, the system comprising a processor configured to:
receive, from a first user associated with a first user trading account, one or more reference account selection criterions;
generate a social index for the first user trading account, comprising an indication of one or more selected reference accounts, selected from a plurality of reference accounts that meet the reference account selection criterions; and
automatically generate at least one trade order for the first user trading account, each of the at least one trade order relating to a respective financial asset, based on automatic trading rules, wherein the automatic trading rules depend on trading activities of the one or more selected reference accounts.

In accordance with an embodiment of the presently disclosed subject matter, there is yet further provided a system wherein the selected reference accounts include two or more user trading accounts.

In accordance with an embodiment of the presently disclosed subject matter, there is yet further provided a system wherein the processor is further configured to execute the at least one trade order.

In accordance with an embodiment of the presently disclosed subject matter, there is yet further provided a system wherein the processor is further configured to calculate a score for the social index based on one or more trading performance parameters of the social index in a certain time frame.

In accordance with an embodiment of the presently disclosed subject matter, there is yet further provided a system wherein the reference account selection criterions include one or more of the following parameters of the one or more reference accounts: trading time frame, user trading account balance, the calculated score of the social index, number of linked copier accounts, gain ratio, winning ratio, maximum drawdown, leverage, exposure, and any combination or derivative thereof.

In accordance with an embodiment of the presently disclosed subject matter, there is yet further provided a system wherein the one or more selected reference accounts are automatically selected.

In accordance with an embodiment of the presently disclosed subject matter, there is yet further provided a system, wherein the automatically selecting is performed according to the ranking of the plurality of reference accounts by the one or more parameters.

In accordance with an embodiment of the presently disclosed subject matter, there is yet further provided a system wherein the one or more selected reference accounts are manually selected.

In accordance with an embodiment of the presently disclosed subject matter, there is yet further provided a system wherein the processor is further configured to assign respective weight factors to each of the one or more selected reference accounts when generating the social index.

In accordance with an embodiment of the presently disclosed subject matter, there is yet further provided a system, wherein the automatic trading rules include copying at least one trade order executed for the one or more selected reference accounts, with an allocated amount of account balance of the first user trading account, based on the account balance of the first user trading account, the investment portfolios of each respective selected reference account and the respective weight factors associated with the respective selected reference account.

In accordance with an embodiment of the presently disclosed subject matter, there is yet further provided a system wherein the processor is further configured to perform the following steps when automatically generating the at least one trade order: aggregate trade orders relating to respective financial assets, wherein the trade orders are executed for at least two of the selected reference accounts, and generate aggregated trade orders for the first user trading account.

In accordance with an embodiment of the presently disclosed subject matter, there is yet further provided a system wherein the automatic trading rules include a condition dependent on one or more of the following variables: market events, market history, open positions of the first user trading account, account balance of the first user trading account, trading activities of the one or more selected reference accounts and any combination or derivative thereof.

In accordance with an embodiment of the presently disclosed subject matter, there is yet further provided a system wherein the processor is further configured to generate, upon regeneration criteria being met, an updated social index comprising an indication of one or more newly selected reference accounts, selected from the plurality of reference accounts that meet the reference account selection criterions.

In accordance with an embodiment of the presently disclosed subject matter, there is yet further provided a system wherein the processor is further configured to assign respective new weight factors to each of the one or more newly selected reference accounts when generating the updated social index.

In accordance with an embodiment of the presently disclosed subject matter, there is yet further provided a system wherein the processor is further configured to receive, from the first user associated with the first user trading account, one or more automatic trading rules.

In accordance with an aspect of the presently disclosed subject matter, there is yet further provided a non-transitory program storage device readable by machine, tangibly embodying a program of instructions executable by the machine to perform a method for facilitating social trading, comprising the steps of:
receiving, from a first user associated with a first user trading account, one or more reference account selection criterions;
generating a social index for the first user trading account, comprising an indication of one or more selected reference accounts, selected from a plurality of reference accounts that meet the reference account selection criterions; and
automatically generating at least one trade order for the first user trading account, each of the at least one trade order relating to a respective financial asset, based on automatic trading rules, wherein the automatic trading rules depend on trading activities of the one or more selected reference accounts.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a block diagram schematically illustrating one example of a system for facilitating social trading, in accordance with the presently disclosed subject matter;

FIG. 2 is a schematic illustration of a linkage relationship between a given User Trading Account A and a Reference Account B with the presently disclosed subject matter;

FIG. 3 is a flowchart illustrating one example of a sequence of operations carried out for generating a social index for a given user trading account, in accordance with the presently disclosed subject matter;

FIG. 4 is a flowchart illustrating one example of a sequence of operations carried out for facilitating social trading, in accordance with the presently disclosed subject matter; and

FIG. 5 is a flowchart illustrating one example of a sequence of operations carried out for generating an updated social index, in accordance with the presently disclosed subject matter.

It will be appreciated that for simplicity and clarity of illustration, elements shown in the figures have not necessarily been drawn to scale. For example, the dimensions and positions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “receiving”, “generating”, “executing”, “calculating”, “selecting”, “assigning”, “copying”, “aggregating”, or the like, include action and/or processes of a computer that manipulate and/or transform data into other data, said data represented as physical quantities, e.g. such as electronic quantities, and/or said data representing the physical objects. The terms “computer”, “processor”, and “controller” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

The operations in accordance with the teachings herein may be performed by a computer specially constructed for the desired purposes or by a general purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

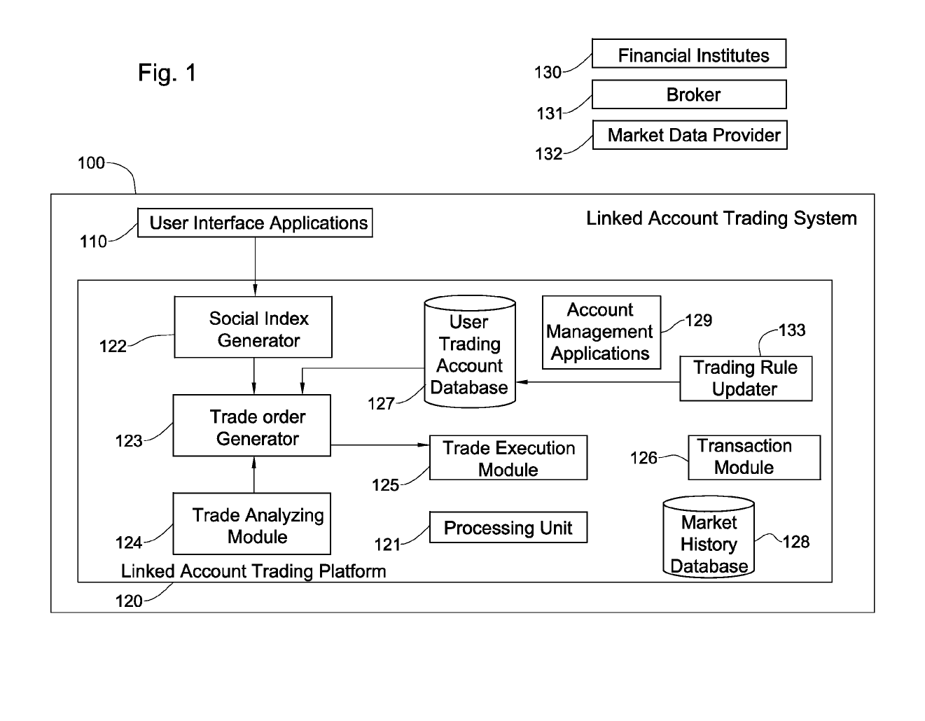

In embodiments of the presently disclosed subject matter, fewer, more and/or different stages than those shown in FIGS. 3, 4 and 5 may be executed. In embodiments of the presently disclosed subject matter one or more stages illustrated in FIGS. 3, 4 and 5 may be executed in a different order and/or one or more groups of stages may be executed simultaneously. FIG. 1 illustrates a general schematic of the system architecture in accordance with an embodiment of the presently disclosed subject matter. Each module in FIG. 1 can be made up of any combination of software, hardware and/or firmware that performs the functions as defined and explained herein. The modules in FIG. 1 may be centralized in one location or dispersed over more than one location. In other embodiments of the presently disclosed subject matter, the system may comprise fewer, more, and/or different modules than those shown in FIG. 1.

Bearing this in mind, attention is drawn to FIG. 1, showing a block diagram schematically illustrating one example of a system for facilitating social trading, in accordance with the presently disclosed subject matter.

Linked Account Trading System (“LATS”) 100 as shown in FIG. 1 implements a social trading mechanism, which enables certain traders (also referred to as users hereinafter) to have at least part of their trading activities automatically determined, or influenced, e.g. in a pre-defined way, by the trading activities of one or more other traders of the trading community. As illustrated, LATS 100 comprises two parts: a Linked Account Trading Platform (“LATP”) 120 at the server side and a User Interface Application 110 at the client side. The User Interface Application 110 is communicatively coupled to the LATP 120, wired or wirelessly, and allows users of LATS 100 to interact with LATS 100 and manipulate the operation of LATP 120. LATP 120 may include at least one processing unit 121 (e.g. digital signal processor (DSP), a microcontroller, a field programmable gate array (FPGA), an application specific integrated circuit (ASIC), or any other device capable of processing data) configured to receive instructions and to manage, control and execute the components and operations of LATP 120. LATP 120 may further include or be functionally associated with the following modules: Social Index generator 122, Trade Order Generator 123, Trade Execution Module 125, and User Trading Account Database 127. Social Index Generator 122 can enable traders to create a Social Index profile comprising an indication of one or more selected reference accounts, e.g. based on a predetermined set of reference account selection criterions (that can, in some cases, be received from the traders, and/or automatically from the LATP 120), as further elaborated with respect to FIG. 3. Trade Order Generator 123 can be configured to receive the generated Social Index profile from Social Index Generator 122, and to produce trade orders for a given user trading account based on automatic trading rules and trading activities of the selected reference accounts, as explained in greater detail with reference to FIG. 3. The automatic trading rules can be received, for example, either from the LATP 120, or directly from the users through User Interface Applications 110. Trade Execution Module 125 is adapted to execute generated trade orders in financial markets or exchanges. The Trade Execution Module 125 may directly execute trades in the financial markets or exchanges, possibly via certain Application Programming Interfaces, or order desired trades from an exterior trade service provider, for example, the broker 131 or the financial institutes 130, or through any other financial asset trading tools and methods thereof.

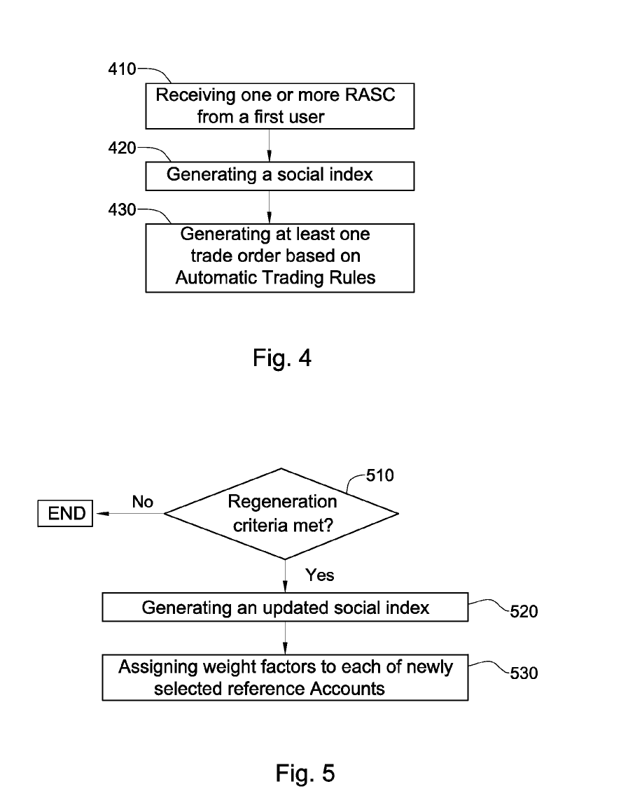

According to certain embodiments, LATP 120 can further include a Trade Analyzing Module 124 adapted to monitor, record and analyze trading activities of different users in LATS 100, and serve the Social Index Generator 122 and Trade Order Generator 123 in their operation, as described further with respect to FIG. 4. According to some other embodiments, LATP 120 can further include a Transaction Module 126 adapted to facilitate monetary transactions between a user and LATS 100, i.e. deposits and withdrawal of funds to or from a user trading account. It may be further adapted to update account balances and positions, based on the user's trading activities. According to further embodiments, there may be provided a Market History Database 128 in LATS 100 which contains data relating to trade history of financial assets, that can be received, for example, from the financial market or exchanges, either directly or via a third party Market Data Provider 132. There may also be provided an Account Management Application 129 which allows a user to update account parameters associated with a user trading account. According to yet further embodiments, there may be provided a Trading Rule Updater 133 adapted to update the automatic trading rules associated with a given user trading account, as further described below.

It is to be noted that User Interface Application 110 can be installed and displayed on a screen of for example PDAs, tablet computers (e.g. Apple iPad), personal computers, laptop computers, cellular phones, smart phones (e.g. iPhone, Blackberry, etc), or any other device suitable to install and display such a user interface.

It is to be further noted that above referred modules in LATS 100 in some cases can be distributed over several locations. In addition, the above referred to modules can in some cases be cloud based.

Alternatively to the example shown in FIG. 1, LATS 100 may in some examples include fewer, more and/or different modules than shown in FIG. 1. Alternatively to the example shown in FIG. 1, the functionality of LATS 100 may in some examples be divided differently among the modules illustrated in FIG. 1. Alternatively to the example shown in FIG. 1, the functionality of LATS 100 described herein may in some examples be divided into fewer, more and/or different modules than shown in FIG. 1 and/or LATS 100 may in some examples include additional, less, and/or different functionality than described herein.

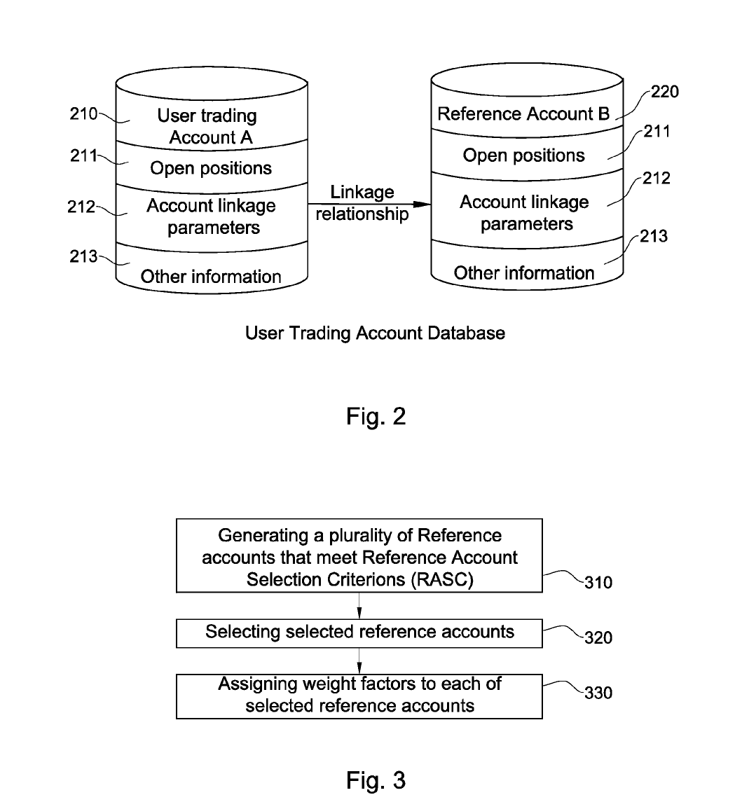

Turning now to FIG. 2, there is shown a schematic illustration of a linkage relationship between a given User Trading Account A and a Reference Account B with the presently disclosed subject matter.

As illustrated, a given User Trading Account A 210 (also referred to as Account A hereinafter) and its Reference Account B 220 are two Linked Accounts stored in the User Trading Account Database 127, which can be included in or be functionally associated with LATS 100, as described in FIG. 1. Information stored in the User Trading Account Database 127 for a given user trading account can include: (1) the account's open positions 211 (i.e. financial assets currently owned and/or owed by the user as a result of trading activities of the given account); and (2) account linkage parameters 212 defining the given account's linkage to other accounts, including indication of one or more Reference Accounts associated therewith, and in some cases also including one or more Automatic Trading Rules, correlating specific trading activities on the linked reference account with corresponding trading activities on the given account, as further described below with reference to FIG. 4. According to some embodiments, a given User Trading Account may further include the following information 213: (3) account balance (e.g. cash/monetary balance available) of the given account; (4) a transaction history for the given account (i.e. monetary transactions between a given user and LATS 100); (5) a trading history comprising parameters and outcomes of trading activities previously performed by the given user. It should be understood that account linkage parameters can further include indication of one or more user trading accounts that follow the trading activities of the given user trading account as a reference account.

As shown in FIG. 2, Account A 210 and Reference Account B 220 are in a linkage relationship, in which the trading activities of Account A (also referred to as the follower account) can be automatically determined or influenced, in some cases, by the trading activates of Account B, possibly based on Account A's automatic trading rules. According to some embodiments, the Account linkage parameters associated with a given user trading account may further include: to what extent, and in which way, to change Automatic Trading Rules of the given account based on correlated trading activities on the Reference Accounts; and any other trading related conditions and/or market related conditions to factor when changing Automatic Trading Rules of the given account.

It is to be noted that although the linkage between Account A and Reference account B is shown in FIG. 2 as unidirectional, those versed in the art will readily appreciate that bidirectional linkage relationship can also be created between a given account and its reference accounts, namely, trading activities of Account A and Reference Account B can be influenced and followed by each other at the same time. A possible solution for this scenario would be, for example, by only allowing Account A and Reference Account B to allocate different amounts of account balance to follow each other's trading activities.

It should be noted that Account A and Reference account B are illustrated for exemplary purposes only. The number of reference accounts linked to a given user trading account and the number of given user accounts following a certain reference account should not be construed as limiting. For example, the linkage relationship between given user accounts and reference accounts can be one-to-one, one-to-multiple, multiple-to-one, or multiple-to-multiple etc. It should be understood that account linkage parameters 212 can further include indication of one or more user trading accounts that follow the trading activities of the given user trading account as a reference account.

It is further to be noted that the information stored in the User Trading Account Database 127 are merely illustrated examples in accordance with certain embodiments to implement the present disclosure, and should not be construed as limiting the present disclosure in any way. Additional fields and information can be applied in addition to or instead of the above.

Having described the linkage relationship between a given user trading account and one or more reference accounts in accordance with certain embodiments, a process of generating a social index for a given user trading account is now described with reference to FIG. 3, in accordance with the presently disclosed subject matter.

As described with respect to FIG. 1, Social Index Generator 122 can enable traders to create a Social Index profile which comprises an indication of one or more selected reference accounts, e.g. based on a predetermined set of reference account selection criterions. Traders can then have at least part of their trading activities automatically determined by following the trading activities of one or more selected reference accounts indicated by the Social Index, e.g. according to certain automatic user trading rules. According to some embodiments, the Social Index Generator 122 can include a Reference Account Selection Module (RASM) adapted to search through a pool of candidate reference accounts in the User Trading Account Database 127, and to generate a plurality of reference accounts that meet certain Reference Account Selection Criterions (RASC), as described in block 310. The RASC can in some cases include a set of static/fixed criterions. Additionally or alternatively the RASC can include a set of dynamic criterions. In some cases, the dynamic criteria's applicability of selection of reference accounts can depend on a variety of dynamic parameters including one or more of the following: trading time frame, user trading account balance, a calculated score of the social index, number of linked follower accounts, gain ratio, winning ratio, maximum drawdown, leverage, exposure, and any combination or derivative thereof. According to certain embodiments, the above referred parameters can be defined as follows:

Trading time frame: The time period that the selection of reference accounts is based on. It can be for example one day, one month or any time period that the trader appoints.

User trading account balance: The cash/monetary balance available of the given account.

Calculated score of the social index: In some cases, a score can be calculated to rate a Social Index based on one or more trading performance parameters of the social index, and/or the number of other user trading accounts following the given account, in a certain time frame. The trading performance parameters can include, for instance, gain ratio, winning ratio, maximum drawdown, leverage, exposure, and any combination or derivative thereof, as explained in greater detail below.

Number of linked follower accounts: The number of user trading accounts that follow the trading activities of a specific reference account.

Gain ratio: The return/profit out of the original account balance.

Winning ratio: The number of winning trades out of total trades.

Maximum drawdown: The largest drop in gain in the specific time frame.

Leverage: A temporary loan given to an investor which allows the trader to partake in substantially larger trades than he/she would otherwise have been able to. The representation of Leverage is, for example, a multiplier showing how much bigger an open position is than the Margin.

Exposure: distribution of investments on different financial assets.

For example, a dynamic RASC defined by a user trading account can include traders that average more than 10% profit per annum on oil. Another example of dynamic RASC would be based on traders that had over 3 positive closed positions in the last three months. Yet another example of dynamic RASC can include traders that have always maintained a positive Social Index score throughout the previous year. An example of static RASC can be that the user chooses to follow a certain reference account, irrespective of the trading activities of the reference account or any other circumstances.

It is to be noted that the specified parameters, together with the definitions of the parameters and examples referred to above are provided for exemplary purposes only and should not be construed as limiting.

After a plurality of reference accounts are generated according to certain RASC as shown in block 310, the user can select a number of selected reference accounts from the generated reference accounts (block 320). The number of selected reference accounts in some cases can be one, and in some other cases, can be two or more. According to some embodiments, the selected reference accounts can be automatically selected according to their rankings by one or more parameters indicated above with reference to the RASC. For example, LATP can automatically select the top ten traders that meet the RASC of averaging more than 10% profit per annum on oil. According to some other embodiments, the selected reference accounts can be manually selected by the users according to their preferences. For example, a user can manually select the 1^{st}, 3^{rd} and 5^{th} traders of the list of reference accounts that meet the RASC of averaging more than 10% profit per annum on oil, possibly based on his/her own trading experience with them. According to some further embodiments, the selection of reference accounts can be a combination of an automatic selection and a manual selection. For example, the top ten traders that meet the RASC of averaging more than 10% profit per annum on oil can be automatically selected by LATP. Additionally, the user can further modify the automatic selection result by adding additional reference accounts or removing certain automatically selected reference accounts from the result.

According to certain embodiments, respective weight factors can be assigned to each of the selected reference accounts (e.g. by the user or automatically), in order to distribute the account balance of the given user trading account accordingly to follow the trading activities of each selected reference account (block 330). For instance, weights can be initially assigned automatically by LATP, for example evenly on each selected reference account, or differently according to a predefined rule. Alternatively, weights can also be assigned by the user, for example according to their rankings in the generated selected list. In some cases weights can further be assigned both automatically and manually. For example, part of the weight factors can be determined automatically by LATP, and the rest of the weight factors can be decided by the user.

According to certain embodiments, the social index can be reviewed, adjusted and updated upon certain regeneration criteria being met, as further described with respect to FIG. 5. For example it can be updated periodically and the frequency of updating the social index can be chosen by the user or decided automatically by LATP. The generated Social Index profile can also be copied or followed by other users in LATS 100.

It is to be noted that the present disclosure is not bound by the specific sequence of operation steps described above with reference to FIG. 3.

Attention is now drawn to FIG. 4, showing a flowchart illustrating one example of a sequence of operations carried out for facilitating social trading, in accordance with the presently disclosed subject matter.

As shown in block 410, LATP can receive one or more Reference Account Selection Criterions (RASC), from a first user associated with a first user trading account. According to certain embodiments, RASC can include a set of criterions that can in some cases depend on a variety of dynamic parameters, as described with respect to FIG. 3. Some exemplary, non-limiting, reference account selection criterions can include: trading time frame, user trading account balance, a calculated score of social index, number of linked follower accounts, gain ratio, winning ratio, maximum drawdown, leverage, exposure, and any derivative thereof. For example, LATP can receive a RASC from the first user including the parameters defined as “trading time frame=the past year” and the “gain ratio >=10%”, and accordingly search for a list of reference accounts that meet the RASC of averaging more than 10% profit in the past year.

Turning now to block 420, after LATP receives one or more RASC from the first user, the Social Index Generator 122 can generate a social index for the first user trading account associated with the first user, as described in detail with respect to FIG. 3. The social index comprises an indication of one or more selected reference accounts, selected from a plurality of reference accounts that meet the RASC. According to certain embodiments, the LATP can further assign respective weight factors to each of the one or more selected reference accounts, as described with reference to block 330.

Next the Trade Order Generator 123 can automatically generate at least one trade order for the first user trading account based on automatic trading rules, as shown in block 430, wherein the automatic trading rules depends on trading activities of the one or more selected reference accounts. For example, a trading activity of a certain reference account purchasing gold can be detected which can then trigger a trade order to be generated for the first user trading account to purchase gold accordingly. According to some embodiments, each of the at least one trade order is related to a respective financial asset.

According to certain embodiments, some or all of the user trading accounts in the LATP can have one or more Automatic Trading Rules associated therewith. The Automatic Trading Rules can comprise trading instructions designed to automatically order certain trades to be generated and executed for the given user trading account when a predefined set of conditions is met. The conditions upon the occurrence of which trade orders will be automatically generated can include one or more variables such as, for example, market events, market history, open positions relating to the given user trading account, account balance of the given user trading account, the trading activities of other traders in the LATP, and any combination or derivatives thereof. According to further embodiments, the Automatic Trading Rules include conditions relating to trading activities of one or more specific traders associated with one or more selected reference accounts that fulfill the RASC of the given user. In some cases, the Automatic Trading Rules are defined as copying at least one trade order executed for the one or more selected reference accounts, with an allocated amount of account balance of the given user trading account (e.g. the first user trading account as referred to above), based on the account balance of the given user trading account, the investment portfolios of each respective selected reference account and the respective weight factors associated with the respective selected reference account.

For example, LATP can receive a predefined RASC as “traders that average more than 10% profit in the past year” from the first user trading account (e.g. Account A, associated with Trader A). The Social Index Generator 122 then automatically generates a list of reference accounts that meet this RASC and select, e.g. the top five reference accounts (e.g. Accounts B to F, associated with Traders B to F) according to the ranking in the list. Next, weight factors are assigned to each of the five selected reference accounts, e.g., evenly 20% for each account. Thus a social index for Account A has been generated, comprising an indication of Accounts B to F with a weight factor of 20% assigned for each account. Assume Account A has an available account balance of USD 1000. According to the assigned weight factors, USD 200 can then be allocated respectively to follow the trading activities of each of the five selected reference accounts. In the case that the Automatic Trading Rule for Account A is defined as “if Traders B to F order any trade, order the same trade for Account A”, Account A can automatically copy or duplicate the trading activities of traders B to F with an allocated amount of account balance of USD 200 for each trader. More specifically, by way of example, if the investment portfolio of Trader B includes: 25% of the account balance invested on gold, 25% on silver, and the rest 50% on oil, the trade orders can be automatically generated for Account A to invest USD 200*25%=USD 50 out of the allocated USD 200 of the account balance of Account A on gold, USD 200*25%=USD 50 on silver and the rest USD 200*50%=USD 100 on oil, either immediately after the Social Index of Account A is generated, or alternatively after a time interval that the Trader A or LATP appoints. Similarly, trade orders can be generated for Account A to copy the trading activities of Traders C to F.

Optionally, instead of generating trade orders respectively to follow the trading activities of each selected reference account, LATP can aggregate trade orders relating to respective financial assets, wherein the trade orders are executed for at least two of the selected reference accounts, and generate aggregated trade orders for the given user trading account. Further to the example illustrated above, assume that Traders C to F also invest a portion of their account balance on gold, e.g. 25% of each account. Instead of generating five trade orders separately to invest USD 50 on gold each time, LATP can aggregate these five trade orders relating to the respective financial asset, in this case gold, and generate an aggregated trade order of USD 50*5=USD 250 to invest on gold for Account A. Similarly, aggregated trade orders relating to silver and oil can also be generated in the same manner, which is clearly more efficient and less costly for Trader A than trade orders being generated separately.

In accordance with certain embodiments, to facilitate the above referred to social trading process, the Trade Analyzing Module 124 as described with respect to FIG. 1 can assist the Social Index Generator 122 in identifying specific users or group of users whose trading history answers certain RASC (e.g. traders that meet the RASC of averaging more than 10% profit in the past year), and it can further assist Trade Order Generator 123 in monitoring the selected reference accounts and their trading activities (e.g. Reference Account B has sold gold related financial assets today) thus serve LATP in its operation.

After the trade orders are generated as shown in block 430, in some cases, the Trade Execution Module 125 can execute the generated trade orders in the financial markets or exchanges, as described with respect to FIG. 1.

Note that the specific examples and numbers illustrated above are provided for exemplary purposes only and should not be construed as limiting. Accordingly, other ways of implementation can be used in addition to or in lieu of the above.

It is to be noted that the present disclosure is not bound by the specific sequence of operation steps described above with reference to FIG. 4.

Turning to FIG. 5 now, there is shown a flowchart illustrating one example of a sequence of operations carried out for generating an updated social Index, in accordance with the presently disclosed subject matter.

According to certain embodiments, upon the occurrence of certain regeneration criteria being met, as shown in the conditional block 510, LATP can generate an updated social index for the first user trading account, comprising an indication of one or more newly selected reference accounts, selected from the plurality of reference accounts that meet the RASC, as shown in block 520. The list of reference accounts that meet certain dynamic RASC constantly changes, due to the changes of trading activities, trading performance and ranking of each trader in the trading community Upon the occurrence of a predefined regeneration criteria being met, a list of newly selected reference accounts according to the RASC is provided, which results in an updated social index. The regeneration criteria can include, for example, a request from a user, a predefined time period, certain user trading activities, and/or certain user monetary transactions and updates of user trading accounts. For example the social index can be updated periodically and the frequency of generating the updated social index can be chosen by the user or decided automatically by LATP. In some cases the user can also define a new set of RASC, according to which an updated social index can be generated. In the case that the regeneration criteria shown in the conditional block 510 are not met, the social index updating process ends, and the regeneration criteria can be monitored and tested (e.g. periodically, continuously, etc.) until being met.

According to some embodiments, new weight factors can be assigned respectively to each of the one or more newly selected reference accounts in a similar way as described with respect to block 330 in FIG. 3.

Further to the example illustrated with respect to FIG. 4, assume that after a certain time period, e.g. one week, an updated social index is generated comprising an indication of a list of newly selected reference accounts, including the original Reference Accounts C to F and a newly joined Account G who was not in the list before. Original Reference Account B does not meet the RASC this time, and thus is no longer included in the newly selected reference account list. Accordingly new weight factors can be assigned to each of the newly selected reference accounts by the user and/or by LATP, for example, 40% on the newly joined Account G, and 15% on each of the rest. In some cases, a first set of trade orders that sell the open positions relating to the trading activities of Account B, and a second set of trade orders that buy the open positions relating to the trading activities of Account G, can be generated. A third set of trade orders that sell part of the open positions relating to the trading activities of the remaining Accounts C to F, according to the difference between the newly allocated amount of account balance of Account A (e.g. USD 150, assuming the available account balance of Account A remains the same as USD 1000) based on the newly assigned weight factors (e.g. 15% each) and the originally allocated amount of account balance (e.g. USD 200) based on the original assigned weight factors (e.g. 20% each), can also be generated for Account A, as described with respect to block 430 in FIG. 4. In a more general manner, it is appreciated that the third set of trade orders that are generated according to the difference between the newly allocated amount and the originally allocated amount of account balance of a given user account can also include buying and/or selling part of the open positions relating to the trading activities of the remaining reference accounts.

Alternatively the first, second and third set of trade orders can be aggregated according to respective financial assets, and aggregated trade orders can be generated for Account A instead of separate ones for each reference account. For example, according to Account B's investment portfolio, USD 200*25%=USD 50 out of the allocated USD 200 of the account balance of Account A was invested on silver. Assume that Account G has 20% of his/her account balance invested also on silver, and Accounts C to F do not have any account balance invested on silver, an aggregated trade order of further investing USD 400*20%−50=USD 30 on silver will be generated instead of selling the open positions of the USD 50 relating to Account B and buying the open positions of the USD 80 relating to Account G. Similarly, other aggregated trade orders can also be generated in the same manner.

Note that the specific examples and numbers illustrated above are provided for exemplary purposes only and should not be construed as limiting. Accordingly, other ways of implementation can be used in addition to or in lieu of the above.

According to yet further embodiments, a given user trading account in LATS can further have Automatic Trading Rule Updating Rules associated with the given account, defining instructions for automatically updating Automatic Trading Rules associated with the given account, based on one or more of the following variables: market events, market history, the trading activities of one or more reference accounts, automatic trading rule changes of one or more reference accounts and any combination or derivatives thereof. As described with respect to FIG. 1, a Trading Rule Updater 133 is adapted to update the automatic trading rules associated with a given user trading account according to the Automatic Trading Rule Updating Rules.

In some cases, the Trading Rule Updater 133 can detect that one or more reference accounts have changed their automatic trading rules or trading activities associated therewith. It can then identify a linkage relationship between a given user trading account and one or more reference accounts, and retrieve the trading rule updating rules of the given user trading account. The trading rule updating rules are associated with the respective linkage relationship with the one or more reference accounts. It can then update the automatic trading rules for the given user trading account based on the one or more variables described above.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A method of facilitating social trading, the method comprising:
receiving, from a first user associated with a first user trading account, one or more reference account selection criterions;
generating a social index for said first user trading account, comprising an indication of one or more selected reference accounts, selected from a plurality of reference accounts that meet said reference account selection criterions; and
automatically generating at least one trade order for said first user trading account, each of said at least one trade order relating to a respective financial asset, based on automatic trading rules, wherein the automatic trading rules depend on trading activities of said one or more selected reference accounts.

2. The method of claim 1 wherein said selected reference accounts include two or more user trading accounts.

3. The method of claim 1 further comprising executing said at least one trade order.

4. The method of claim 1 further comprising calculating a score for said social index based on one or more trading performance parameters of said social index in a certain time frame.

5. The method of claim 4 wherein said reference account selection criterions include one or more of the following parameters of said one or more reference accounts: trading time frame, user trading account balance, said calculated score of said social index, number of linked copier accounts, gain ratio, winning ratio, maximum drawdown, leverage, exposure, and any combination or derivative thereof.

6. The method of claim 5 wherein said one or more selected reference accounts are automatically selected.

7. The method of claim 6, wherein said automatically selecting is performed according to the ranking of said plurality of reference accounts by said one or more parameters.

8. The method of claim 1 wherein said one or more selected reference accounts are manually selected.

9. The method of claim 1 wherein said generating said social index further comprises assigning respective weight factors to each of said one or more selected reference accounts.

10. The method of claim 9, wherein said automatic trading rules include copying at least one trade order executed for said one or more selected reference accounts, with an allocated amount of account balance of said first user trading account, based on the account balance of said first user trading account, the investment portfolios of each respective selected reference account and the respective weight factors associated with the respective selected reference account.

11. The method of claim 1 wherein said automatically generating the at least one trade order includes:
aggregating trade orders relating to respective financial assets, wherein said trade orders are executed for at least two of said selected reference accounts, and
generating aggregated trade orders for said first user trading account.

12. The method of claim 1 wherein said automatic trading rules include a condition dependent on one or more of the following variables: market events, market history, open positions of the first user trading account, account balance of the first user trading account, trading activities of said one or more selected reference accounts and any combination or derivative thereof.

13. The method of claim 1 further comprising generating, upon regeneration criteria being met, an updated social index comprising an indication of one or more newly selected reference accounts, selected from the plurality of reference accounts that meet said reference account selection criterions.

14. The method of claim 13 wherein said generating an updated social index further comprises assigning respective new weight factors to each of the one or more newly selected reference accounts.

15. The method of claim 1 wherein said receiving further comprises receiving, from said first user associated with said first user trading account, one or more automatic trading rules.

16. A system for social trading, the system comprising a processor configured to:
receive, from a first user associated with a first user trading account, one or more reference account selection criterions;
generate a social index for said first user trading account, comprising an indication of one or more selected reference accounts, selected from a plurality of reference accounts that meet said reference account selection criterions; and
automatically generate at least one trade order for said first user trading account, each of said at least one trade order relating to a respective financial asset, based on automatic trading rules, wherein the automatic trading rules depend on trading activities of said one or more selected reference accounts.

17. The system of claim 16 wherein said selected reference accounts include two or more user trading accounts.

18. The system of claim 16 wherein said processor is further configured to execute said at least one trade order.

19. The system of claim 16 wherein said processor is further configured to calculate a score for said social index based on one or more trading performance parameters of said social index in a certain time frame.

20. The system of claim 19 wherein said reference account selection criterions include one or more of the following parameters of said one or more reference accounts: trading time frame, user trading account balance, said calculated score of said social index, number of linked copier accounts, gain ratio, winning ratio, maximum drawdown, leverage, exposure, and any combination or derivative thereof.

21. The system of claim 20 wherein said one or more selected reference accounts are automatically selected.

22. The system of claim 21, wherein said automatically selecting is performed according to the ranking of said plurality of reference accounts by said one or more parameters.

23. The system of claim 16 wherein said one or more selected reference accounts are manually selected.

24. The system of claim 16 wherein said processor is further configured to assign respective weight factors to each of said one or more selected reference accounts when generating said social index.

25. The system of claim 24, wherein said automatic trading rules include copying at least one trade order executed for said one or more selected reference accounts, with an allocated amount of account balance of said first user trading account, based on the account balance of said first user trading account, the investment portfolios of each respective selected reference account and the respective weight factors associated with the respective selected reference account.

26. The system of claim 16 wherein said processor is further configured to perform the following steps when automatically generating the at least one trade order:
aggregate trade orders relating to respective financial assets, wherein said trade orders are executed for at least two of said selected reference accounts, and
generate aggregated trade orders for said first user trading account.

27. The system of claim 16 wherein said automatic trading rules include a condition dependent on one or more of the following variables: market events, market history, open positions of the first user trading account, account balance of the first user trading account, trading activities of said one or more selected reference accounts and any combination or derivative thereof.

28. The system of claim 16 wherein said processor is further configured to generate, upon regeneration criteria being met, an updated social index comprising an indication of one or more newly selected reference accounts, selected from the plurality of reference accounts that meet said reference account selection criterions.

29. The system of claim 28 wherein said processor is further configured to assign respective new weight factors to each of the one or more newly selected reference accounts when generating said updated social index.

30. The system of claim 16 wherein said processor is further configured to receive, from said first user associated with said first user trading account, one or more automatic trading rules.

31. A non-transitory program storage device readable by machine, tangibly embodying a program of instructions executable by the machine to perform a method for facilitating social trading, comprising the steps of:
receiving, from a first user associated with a first user trading account, one or more reference account selection criterions;
generating a social index for said first user trading account, comprising an indication of one or more selected reference accounts, selected from a plurality of reference accounts that meet said reference account selection criterions; and
automatically generating at least one trade order for said first user trading account, each of said at least one trade order relating to a respective financial asset, based on automatic trading rules, wherein the automatic trading rules depend on trading activities of said one or more selected reference accounts.
